(19) United States
(12) Patent Application Publication
(10) Pub. No.: US 2026/0300493 A1
(43) Pub. Date: Oct. 1, 2026

(54) OPTION ROM CONTAINERIZATION

(71) Applicant: Lenovo Global Technology (United States) Inc., Morrisville, NC (US)

(72) Inventors: Benjamin Frisch, Orlando, FL (US); Zane Ali, Orangevale, CA (US); Jordan Ferguson, Montgomery, TX (US); Jeffrey Brian Pitts, Durham, NC (US)

(21) Appl. No.: 19/093,762

(22) Filed: Mar. 28, 2025

(51) Int. Cl. G06F 21/57; G06F 21/54; G06F 21/60

(52) U.S. Cl. CPC G06F 21/575; G06F 21/54; G06F 21/604

(57) ABSTRACT

A method includes creating, during a boot process of a computing device, an option ROM container running on the computing device and importing option ROM code from an option ROM into the container. The option ROM is located on a component being installed on the computing device and includes untrusted code. The method includes initiating a setup process during the boot process that includes allowing a user to select a level of access of one or more option ROM processes of the option ROM code. The method includes modifying settings within boot process code based on user selections of levels of access of the one or more option ROM processes to computer processes and components of the computing device external to the option ROM container, and configuring, during execution of the boot process code, access of the one or more option ROM processes based on the user selections.

### FIELD

The subject matter disclosed herein relates to use of code from option read-only memory and more particularly relates to limiting access to code from option ROMs.

### BACKGROUND

Option ROMs are images of code associated with components being installed on a computing device, where the components may be external PCIe devices or other components that include untrusted code. Option ROM code is executable code that runs as part of the Unified Extensible Firmware Interface (“UEFI”) or other firmware boot process. The option ROM code is usually not written by a manufacturer or any integrated system vendor trusted by the manufacturer. This introduces untrusted code into the system’s boot process.

### BRIEF SUMMARY

A method for option ROM containerization is disclosed. An apparatus and a system also perform the functions of the method. The method includes creating, during a boot process of a computing device, an option ROM container running on the computing device and importing option ROM code from an option ROM into the option ROM container. The option ROM is located on a component being installed on the computing device and includes untrusted code. The method includes initiating an option ROM setup process during the boot process. The option ROM setup process includes allowing a user to select a level of access of one or more option ROM processes of the option ROM code. The method includes modifying settings within boot process code of the boot process based on user selections of levels of access of the one or more option ROM processes to computer processes and components of the computing device external to the option ROM container, and configuring, during execution of the boot process code, access of the one or more option ROM processes based on the user selections.

An apparatus for option ROM containerization includes a processor of a computing device and non-transitory computer readable storage media storing code. The code is executable by the processor to perform operations that include, during a boot process of the computing device, creating an option ROM container running on the computing device and importing option ROM code from an option ROM into the option ROM container. The option ROM is located on a component being installed on the computing device and includes untrusted code. The operations include initiating an option ROM setup process during the boot process, where the option ROM setup process includes allowing a user to select a level of access of one or more option ROM processes of the option ROM code. The operations include modifying settings within boot process code of the boot process based on user selections of levels of access of the one or more option ROM processes to computer processes and components of the computing device external to the option ROM container, and configuring, during execution of the boot process code, access of the one or more option ROM processes based on the user selections.

A system for option ROM containerization includes a computing device with a processor and a component being installed on the computing device. The component includes an option ROM. The option ROM includes untrusted code. The computing device includes non-transitory computer readable storage media storing code. The code is executable by the processor to perform operations that include, during a boot process of the computing device, creating an option ROM container running on the computing device. The operations include importing option ROM code from the option ROM into the option ROM container and initiating an option ROM setup process during the boot process. The option ROM setup process includes allowing a user to select a level of access of one or more option ROM processes of the option ROM code. In some embodiments, the operations include modifying settings within boot process code of the boot process based on user selections of levels of access of the one or more option ROM processes to computer processes and components of the computing device external to the option ROM container, and configuring, during execution of the boot process code, access of the one or more option ROM processes based on the user selections.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for option ROM containerization, according to various embodiments;

FIG. 2 is a schematic block diagram illustrating an apparatus for option ROM containerization, according to various embodiments;

FIG. 3 is a schematic block diagram illustrating another apparatus for option ROM containerization, according to various embodiments;

FIG. 4 is a schematic block diagram illustrating a menu for selecting options for option ROM containerization, according to various embodiments;

FIG. 5 is a schematic block diagram illustrating a system table currently in use for option ROM code and a containerized system table, according to various embodiments;

FIG. 6 is a schematic flow chart diagram illustrating options for option ROM containerization, according to various embodiments;

FIG. 7 is a schematic flow chart diagram illustrating a method for option ROM containerization, according to various embodiments; and

FIG. 8 is a schematic flow chart diagram illustrating another method for user selection of options for option ROM containerization, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the "C" programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for option ROM containerization is disclosed. An apparatus and a system also perform the functions of the method. The method includes creating, during a boot process of a computing device, an option ROM container running on the computing device and importing option ROM code from an option ROM into the option ROM container. The option ROM is located on a component being installed on the computing device and includes untrusted code. The method includes initiating an option ROM setup process during the boot process. The option ROM setup process includes allowing a user to select a level of access of one or more option ROM processes of the option ROM code. The method includes modifying settings within boot process code of the boot process based on user selections of levels of access of the one or more option ROM processes to computer processes and components of the computing device external to the option ROM container, and configuring, during execution of the boot process code, access of the one or more option ROM processes based on the user selections.

In some embodiments, modifying the settings within the boot process code includes configuring the container with the option ROM code based on the user selections of the levels of access of the one or more option ROM processes. In other embodiments, the levels of access include an unrestricted mode and a restricted mode. User selection of the unrestricted mode includes configuring the option ROM container to allow access by the one or more option ROM processes to the computer processes and components and user selection of the restricted mode includes configuring the option ROM container to restrict access for one or more of the one or more option ROM processes to the computer processes and the components. In other embodiments, selection of the restricted mode includes displaying a menu that includes level of access options for the one or more option ROM processes.

In other embodiments, for the one or more option ROM processes, the level of access options of the menu include disallowing access, a one-time allowance of access, and/or permanent allowance of access to the computer processes and the components. The disallowing access includes preventing access by the one or more option ROM processes to the computer processes and components. The one-time allowance of access includes a one-time allowance, until another boot process, of access by a process of the one or more option ROM processes to the computer processes and the components. The permanent allowance of access includes a permanent allowance of access by a process of the one or more option ROM processes to the computer processes and components.

In some embodiments, in the restricted mode, the method includes offering a user selection of an interactive mode. In response to the user selecting the interactive mode and in response to the user selecting to disallow access for a process of the one or more option ROM processes and in response to the process requesting access during runtime, the method includes displaying a prompt to the user to select disallowance of access for the process, to select a one-time allowance of access for the process, and to select a permanent allowance of access for the process. In other embodiments, user selection of the disallowing of the access for the one or more option ROM processes includes retaining settings of the boot process code for the one or more option ROM processes. The one-time allowance of the access for the process of the one or more option ROM processes includes retaining settings of the boot process code for the process of the one or more option ROM processes and a one-time allowance, until another boot process, of access by a process of the one or more option ROM processes to the computer processes and the components, and user selection of the permanent allowance of access for the process of the one or more option ROM processes includes modifying the boot process code to allow access to the process of the one or more option ROM processes.

In some embodiments, the method includes offering the user an audit option. A selection by the user of the audit option includes logging of access or denial of access for each of the one or more option ROM processes. In other embodiments, the boot process code includes code for a Unified Extensible Firmware Interface (“UEFI”) process or a basic input/output system (“BIOS”) process. In other embodiments, the method includes isolating the option ROM code of the option ROM on the component being installed from execution and enabling execution of the option ROM code of the option ROM imported to the option ROM container.

An apparatus for option ROM containerization includes a processor of a computing device and non-transitory computer readable storage media storing code. The code is executable by the processor to perform operations that include, during a boot process of the computing device, creating an option ROM container running on the computing device and importing option ROM code from an option ROM into the option ROM container. The option ROM is located on a component being installed on the computing device and includes untrusted code. The operations include initiating an option ROM setup process during the boot process, where the option ROM setup process includes allowing a user to select a level of access of one or more option ROM processes of the option ROM code. The operations include modifying settings within boot process code of the boot process based on user selections of levels of access of the one or more option ROM processes to computer processes and components of the computing device external to the option ROM container, and configuring, during execution of the boot process code, access of the one or more option ROM processes based on the user selections.

In some embodiments, modifying the settings within the boot process code includes configuring the container with the option ROM code based on the user selections of the levels of access of the one or more option ROM processes. In other embodiments, the levels of access include an unrestricted mode and a restricted mode. User selection of the unrestricted mode includes configuring the option ROM container to allow access by the one or more option ROM processes to the computer processes and components and user selection of the restricted mode includes configuring the option ROM container to restrict access for one or more of the one or more option ROM processes to the computer processes and the components. In other embodiments, the operations for selection of the restricted mode include operations for displaying a menu that includes level of access options for the one or more option ROM processes.

In some embodiments, for the one or more option ROM processes, the level of access options of the menu include disallowing access, a one-time allowance of access, and/or permanent allowance of access to the computer processes and the components. The disallowing access includes preventing access by the one or more option ROM processes to the computer processes and components. The one-time allowance of access includes a one-time allowance, until another boot process, of access by a process of the one or more option ROM processes to the computer processes and the components. The permanent allowance of access includes a permanent allowance of access by a process of the one or more option ROM processes to the computer processes and components.

In other embodiments, in the restricted mode, the operations include offering a user selection of an interactive mode. In response to the user selecting the interactive mode and in response to the user selecting to disallow access for a process of the one or more option ROM processes and in response to the process requesting access during runtime, the operations include displaying a prompt to the user to select disallowance of access for the process, to select a one-time allowance of access for the process, and to select a permanent allowance of access for the process. In other embodiments, the operations include offering the user an audit option. A selection by the user of the audit option includes logging of access or denial of access for each of the one or more option ROM processes.

A system for option ROM containerization includes a computing device with a processor and a component being installed on the computing device. The component includes an option ROM. The option ROM includes untrusted code. The computing device includes non-transitory computer readable storage media storing code. The code is executable by the processor to perform operations that include, during a boot process of the computing device, creating an option ROM container running on the computing device. The operations include importing option ROM code from the option ROM into the option ROM container and initiating an option ROM setup process during the boot process. The option ROM setup process includes allowing a user to select a level of access of one or more option ROM processes of the option ROM code. In some embodiments, the operations include modifying settings within boot process code of the boot process based on user selections of levels of access of the one or more option ROM processes to computer processes and components of the computing device external to the option ROM container, and configuring, during execution of the boot process code, access of the one or more option ROM processes based on the user selections.

In some embodiments, the levels of access include an unrestricted mode and a restricted mode. The unrestricted mode configures the container to allow access by the one or more option ROM processes to the computer processes and components and the restricted mode configures the container to restrict access for one or more of the one or more option ROM processes to the computer processes and the components. In other embodiments, the operations for selection of the restricted mode include operations for displaying a menu that includes level of access options for the one or more option ROM processes. For the one or more option ROM processes, the level of access options of the menu include disallowing access, a one-time allowance of access, and/or permanent allowance of access to the computer processes and the components. The disallowing access includes preventing access by the one or more option ROM processes to the computer processes and components. The one-time allowance of access includes a one-time allowance, until another boot process, of access by a process of the one or more option ROM processes to the computer processes and the components. The permanent allowance of access includes a permanent allowance of access by a process of the one or more option ROM processes to the computer processes and components. In the restricted mode, the operations include offering a user selection of an interactive mode. In response to the user selecting the interactive mode and in response to the user selecting to disallow access for a process of the one or more option ROM processes and in response to the process requesting access during runtime, the operations include displaying a prompt to the user to select disallowance of access for the process, to select a one-time allowance of access for the process, and to select a permanent allowance of access for the process.

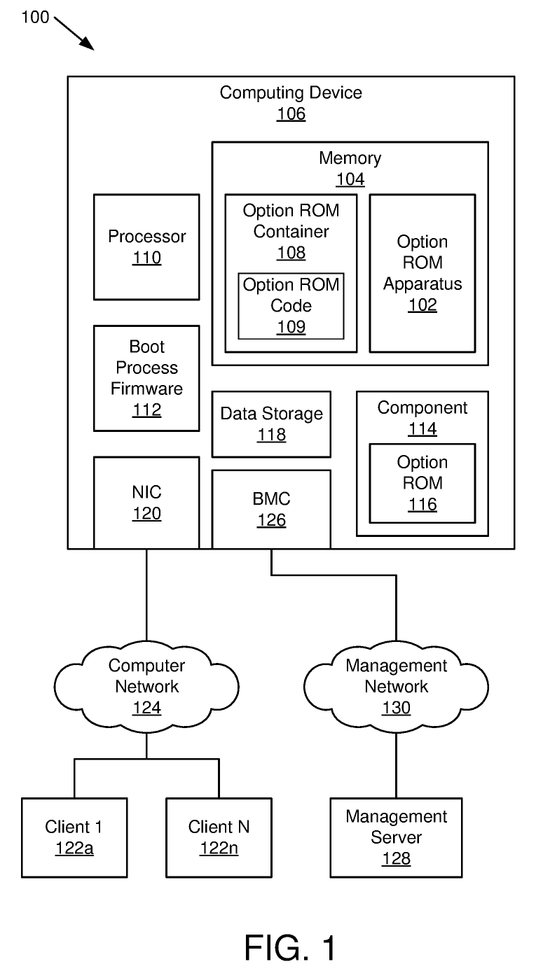

FIG. 1 is a schematic block diagram illustrating a system 100 for option read-only memory (“ROM”) containerization, according to various embodiments. The system 100 includes an option ROM apparatus 102 in memory 104 of a computing device 106. The computing device 106 includes an option ROM container 108 with option ROM code 109 in memory 104, a processor 110, boot process firmware 112, a component 114 with an option ROM 116, non-volatile data storage 118, a network interface card (“NIC”) 120 connected to clients 1-N 122a-122n (individually or generically “client(s) 122”) over a computer network 124, and a baseboard management controller (“BMC”) 126 connected to a management server 128 over a management network 130, which are described below.

The system 100 includes an option ROM apparatus 102 configured to limit access to option ROM code 109 from an option ROM 116 of a component 114 where the option ROM code 109 is untrusted. The option ROM apparatus 102 is configured to create, during a boot process of the computing device 106, an option ROM container 108 and to import option ROM code 109 from the option ROM 116 into the option ROM container 108. The option ROM container 108 is then configured to limit access of the option ROM code 109 as appropriate. The option ROM apparatus 102 is configured to initiate an option ROM setup process during the boot process where the option ROM setup process includes allowing a user to select a level of access of one or more option ROM processes of the option ROM code 109 and to modify settings within boot process code of the boot process based on user selections of levels of access of the one or more option ROM processes to computer processes and components of the computing device 106 external to the option ROM container 108. The access includes access to devices external to the computing device 106. The option ROM apparatus 102 configures, during execution of the boot process code, access of the one or more option ROM processes based on the user selections. The option ROM apparatus 102 is described in more detail below.

The computing device 106 includes memory 104, which in some embodiments is volatile memory. In other embodiments, the memory 104 includes non-volatile memory, such as solid-state flash memory. The memory 104 is communicatively coupled with the processor 110. In some embodiments, the option ROM apparatus 102 is stored in non-volatile data storage 118 and some or all of the option ROM apparatus 102 is loaded by the processor 110 into the memory 104 as necessary to execute code of the option ROM apparatus 102. In some embodiments, the memory 104 includes multiple types of memory, such as various levels of cache, shared memory, etc.

The memory 104 includes an option ROM container 108, which is created by the option ROM apparatus 102 for the option ROM code 109. In some embodiments, the option ROM container 108 is used to isolate the option ROM code 109 from other elements of the computing device 106, from the clients 122, from network devices, etc. Typical containers use the operating system (“OS”) of the computing device 106 hosting the container while maintaining code operating within the container separate from other applications, processes, etc. running on the processor 110 and limiting access of the code running in the option ROM code 109 to processes, components, devices, etc. external to the option ROM container 108. In some embodiments, the boot process firmware mechanisms host the option ROM container.

Containers, in some embodiments, are able to execute commands a root, have a private network interface and internet protocol (“IP”) address, allow custom routes and IP table rules, can mount file systems, etc. Containers allow a user to customize access to components, processes, etc. of the computing device 106 and to external devices. While an option ROM container 108 is depicted, in other embodiments, the computing device 106 includes a virtual machine (“VM”) in memory 104 that includes the option ROM code 109. A VM has all of the isolation and protections of a container but each VM runs a separate instance of an operating system, which are all controlled by a hypervisor. The option ROM apparatus 102 sets up access to the option ROM code 109 via the option ROM container 108 or a VM with the option ROM code 109.

The computing device 106 includes a processor 110. In some embodiments, the processor 110 includes multiple cores. In other embodiments, the computing device 106 includes multiple processors. In some embodiments, the computing device 106 includes a processor 110 that controls other processors and/or cores. The processor 110 is configured to execute code of the option ROM apparatus 102, the option ROM code 109 when in the option ROM container 108, as well as other applications and processes of the computing device 106.

The computing device 106 includes boot process firmware 112 configured to start up and configure the computing device 106 after power on of the computing device 106. In some embodiments, the computing device 106 is in a sleep mode and the boot process firmware 112 is used to bring the operating system of the computing device 106 back to full operation. In some embodiments, the boot process firmware 112 is configured as a Unified Extensible Firmware Interface (“UEFI”). In other embodiments, the boot process firmware 112 is configured using another legacy firmware format, such as a basic input/output system (“BIOS”). In other embodiments, the boot process firmware 112 uses another protocol, such as a protocol replacing UEFI.

Typically, during a boot process the boot process firmware 112 starts the operating system of the computing device 106 and goes through a configuration process to configure various components of the computing device 106. Typically, the components include code stored in a ROM on the component where the code is uploaded to memory 104 and is treated as trusted so that whatever processes run by the code have full access to other components and processes of the computing device 106, to the clients 122, etc. However, in some instances a component 114 is installed on the computing device 106 from a vendor that has not been fully vetted and includes an option ROM 116 with code that is untrusted. In current computing devices 106, the option ROM code is loaded into memory 104 and has full access to components and processes of the computing device 106 and has access to external devices, such as the clients 122. The option ROM apparatus 102 with the option ROM code 109 in the option ROM container 108 customizes access by the option ROM code 109 based on user preferences to allow the user to limit access of the option ROM code 109. Typically, the level of access to the one or more processes of the option ROM code 109 is set up during the boot process. In other embodiments, some or all of the option ROM apparatus 102 runs on the operating system of the computing device 106.

In some embodiments, the component 114 with the option ROM 116 is an internal component of the computing device 106. In other embodiments, the component 114 with the option ROM 116 functions as an external interface, such as a peripheral component interconnect express (“PCIe”) network interface, which may function as a network interface card and is configured to communicate with clients 122 and other external devices. The component 114 with the option ROM 116, in some embodiments, is from a manufacturer that is untrusted or from a supplier that is untrusted. In other embodiments, the component 114 is from a trusted manufacturer, but the code on the option ROM is untrusted. When the component 114 or the code on the option ROM 116 is untrusted, importing the option ROM code 109 into the option ROM container 108 is desirable to control the level of access of processes of the option ROM code 109.

The computing device 106 includes, in some embodiments, non-volatile data storage 118. In other embodiments, the computing device 106 has access to external non-volatile data storage. In some embodiments, the computing device 106 has internal non-volatile data storage 118 and also has access to external non-volatile data storage. The non-volatile data storage 118, in various embodiments, includes solid-state storage, a hard disk drive, optical storage, or the like. In some embodiments, the internal non-volatile data storage 118 includes a copy of the option ROM apparatus 102.

The computing device 106 includes, in some embodiments, a network interface card (“NIC”) 120 configured to facilitate communication with clients 122 and other external computing devices. In other embodiments, the component 114 functions as a NIC. The clients 122, in various embodiments, are configured to submit tasks, workloads, etc. to the computing device 106, which may be operating as a server. In some embodiments, the computing device 106 is part of a cloud computing system. In various embodiments, the computing device 106 is a rack-mounted server, is a blade server, is a desktop computer, is a workstation, is a mainframe computer, or the like. The clients 122 may also be servers, desktop computers, laptop computers, smartphones, smart appliances, or other computing device that requires access to services of the computing device 106. In other embodiments, the computing device 106 is connected over the computer network 124 to servers, printers, routers, switches, data storage devices, and other computing devices.

In some embodiments, the computing device 106 includes a BMC 126 connected to a management server 128 over a management network 130. In some embodiments, the BMC 126 is an XClarity® Controller (“XCC”) by Lenovo®. In other embodiments, the BMC 126 is Management Engine (“ME”) by Intel®. In other embodiments, the BMC 126 is another type by another manufacturer. In general, a BMC in a computing device 106, such as an edge computing device, server in a datacenter, etc. may be a controller used to monitor and manage the computing device 106 remotely. The BMC 126 may be, for example, used for health monitoring, power management, firmware management, event logging, security, etc.

In some embodiments, the BMC 126 is configured to communicate with a management server 128 over a management network 130. In some embodiments, the management server 128 is an XClarity Administrator (“XCA”) by Lenovo. In some embodiments the management server 128 is on-site with numerous computing devices 106, which may be rack-mounted servers. In some embodiments, the management server 128 is connected over a management network 130 to an off-site management server. In various embodiments, the off-site management server is an XCA or an XClarity Orchestrator (“XCO”) by Lenovo. In some embodiments, the BMC 128 controls initiating the boot process.

In some embodiments, the management network 130 is separate from the computer network 124 connected to the clients 122. In other embodiments, the management network 130 runs through the NIC 120 and is isolated from other network traffic. In some embodiments, the management network 130 uses a virtual private network (“VPN”) or other secure connection.

In some embodiments, the computer network 124 and/or the management network 130 include a LAN, a WAN, a metropolitan area network (“MAN”), a fiber network, or the like. In some embodiments, the computer network 124 and/or the management network 130 include a wireless connection. In various embodiments, the computer network 124 and/or the management network 130 include servers, cables, switches, routers, and other network components.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

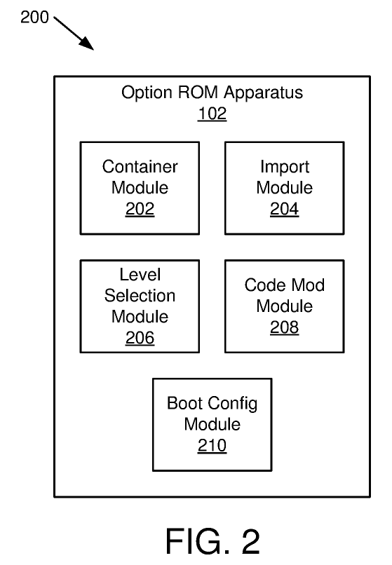

FIG. 2 is a schematic block diagram illustrating an apparatus 200 for option ROM containerization, according to various embodiments. The apparatus 200 includes an option ROM apparatus 102 with a container module 202, an import module 204, a level selection module 206, a code modification module 208, and a boot configuration module 210, which are described below. In some embodiments, all or a portion of the apparatus 200 is implemented using executable code stored on non-transitory computer readable media. In other embodiments, all or a portion of the apparatus 200 is implemented using a programmable hardware device and/or hardware circuits.

The apparatus 200 includes a container module 202 configured to create, during a boot process of a computing device 106, an option ROM container 108 running on the computing device 106. The apparatus 200 includes an import module 204 configured to import option ROM code 109 from an option ROM 116 into the option ROM container 108. The option ROM 116 is located on a component 114 being installed on the computing device 106 and includes untrusted code.

The component 114 is being installed on the computing device 106 and is untrusted in some way. The component 114 includes an option ROM 116 that includes code that includes options, drivers, code, etc. for operation of the component 114. Typically, manufacturers include a ROM with code to run the component 114 so that the code is shipped with the component 114. The component 114 may be internal to the computing device 106 or may include an interface for external communications. Importing the option ROM code 109 includes copying the code stored on the option ROM 116 to the option ROM container 108 for execution. In some embodiments, the code on the option ROM 116 is not read after being copied to the option ROM container 108.

The option ROM container 108 is created specifically for the option ROM code 109 and is configured to isolate the option ROM code 109 from other components, processes, etc. of the computing device 106 and from external devices so that one or more processes of the option ROM code 109 do not have access outside the option ROM container 108. In some embodiments, the boot process of the computing device 106 is a UEFI boot process. In other embodiments, the boot process of the computing device 106 is a BIOS boot process. In other embodiments, the boot process is another type of boot process.

In some embodiments, the option ROM container 108 executes using the operating system of the computing device 106 and provides operating-system-level virtualization by abstracting the “user space” that is a private space for processing and the option ROM container 108 is able to execute commands as root, has a private network interface IP address, allows custom routes and IP table rules, is able to mount file systems, and/or the like. In some embodiments, the computing device 106 includes multiple containers. In some embodiments, the option ROM container 108 includes separate bins and libraries. In some embodiments, the option ROM is controlled by a Docker engine, which controls all containers of the computing device 106. Docker is an open-source project based on Linux®. Docker uses Linux Kernel features, like namespaces and control groups to create containers on top of the operating system of the computing device 106. In other embodiments, another engine protocol is used to control the containers of the computing device 106.

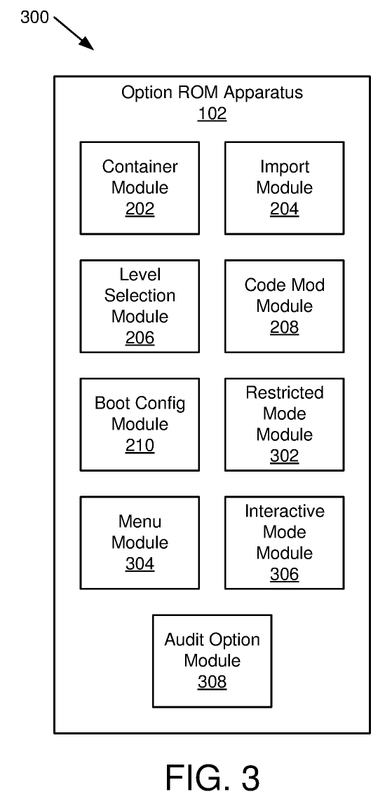

The apparatus 200 includes a level selection module 206 configured to initiate an option ROM setup process during the boot process. The option ROM setup process includes allowing a user to select a level of access of one or more option ROM processes of the option ROM code 109. In some embodiments, the level selection module 206 presents configuration choices to the user via an electronic display and allows the user to choose, for each option ROM process of the option ROM code 109 that requires access to a process, to a component, to an external device, etc. of the computing device 106. Various options are discussed in more detail with respect to the apparatus 300 of FIG. 3.

The apparatus 200 includes a code modification module 208 configured to modify settings within boot process code of the boot process based on user selections of levels of access of the one or more option ROM processes to computer processes and components of the computing device 106 external to the option ROM container 108. The apparatus 200 includes a boot configuration module 210 configured to configure, during execution of the boot process code, access of the one or more option ROM processes based on the user selections.

In some embodiments, a user is able to select disallowing access so the code modification module 208 makes no changes to the settings of the boot process code where the default is no access for the option ROM container 108. In addition, the boot configuration module 210 does not configure access for the option ROM process.

In other embodiments, the boot configuration module 210 configures access of the option ROM process to allow temporary access a process of the option ROM code 109 until the next boot process of the computing device 106. The code modification module 208 does not modify a setting for the option ROM process for a next boot process. When the computing device 106 is restarted, the option ROM process that was in a one-time access mode is not automatically granted access. In other embodiments, the user selects permanent access for an option ROM process and the code modification module 208 changes settings in the boot process code so that during the next boot process the option ROM process will have requested access to whatever process, component, etc. that the option ROM process requests. The boot configuration module 210 also configures access for the option ROM process to the process, component, etc. that the option ROM process requests. Once the settings are changed by the code modification module 208 and access is established by the code modification module 208, the boot configuration module 210 finishes the boot process and configures access to the one or more option ROM processes based on the user selections.

FIG. 3 is a schematic block diagram illustrating another apparatus 300 for option ROM containerization, according to various embodiments. The apparatus 300 includes an option ROM apparatus 102 with a container module 202, an import module 204, a level selection module 206, a code modification module 208, and a boot configuration module 210, which are substantially similar to those described above in relation to the apparatus 200 of FIG. 2. The apparatus 300, in various embodiments, includes a restricted mode module 302, a menu module 304, an interactive mode module 306, and/or an audit option module 308, which are described below. In some embodiments, all or a portion of the apparatus 300 is implemented using executable code stored on non-transitory computer readable media. In other embodiments, all or a portion of the apparatus 300 is implemented using a programmable hardware device and/or hardware circuits.

The apparatus 300 includes, in some embodiments, a restricted mode module 302 configured to determine whether the user has selected an unrestricted mode or a restricted mode. Where the restricted mode module 302 determines that the user has selected the unrestricted mode, the restricted mode module 302 configures the option ROM container 108 to allow access by the one or more option ROM processes to the computer processes and components of the computing device 106. Thus, in the unrestricted mode, the option ROM processes are allowed full access to the processes and components of the computing device 106 as well as to external devices.

Where the restricted mode module 302 determines that the user has selected of the restricted mode, the restricted mode module configures the option ROM container 108 to restrict access for one or more of the one or more option ROM processes to the computer processes and the components of the computing device 106. The levels of access of the option ROM processes depend upon further user selection of various options.

The apparatus 300 includes, in some embodiments, a menu module 304 configured to display a menu that includes level of access options for the one or more option ROM processes. In some embodiments, the level of access options of the menu include disallowing access, a one-time allowance of access, and/or permanent allowance of access to the computer processes and the components of the computing device 106. In other embodiments, the level of access options are different and may be specific to the option ROM processes. The disallowing access includes preventing access by the one or more option ROM processes to the computer processes and components of the computing device 106. Thus, when an option ROM process attempts to access a process, component, etc. external to the option ROM container 108, the option ROM process will be denied access where “disallow access” is selected by the user.

In embodiments that include a one-time allowance, the one-time allowance of access includes a one-time allowance, until another boot process, of access by a process of the one or more option ROM processes to the computer processes and the components of the computing device 106 and to external devices. As used herein “computer processes and components” are those external to the option ROM container 108 and include components and processes of the computing device 106 as well as devices external to the computing device 106. Thus, the option ROM process with one-time allowance access has access to a requested process, component, etc. until the computing device 106 is rebooted. In some embodiments, during the reboot process the menu module 304 presents at least the option ROM process granted one-time access for the user to again select disallowing the access, another one-time access, or permanent access.

The permanent allowance of access includes a permanent allowance of access by a process of the one or more option ROM processes to the computer processes and components of the computing device 106. In the embodiment, the code modification module 208 changes the settings in the boot process code to allow the option ROM process access to a process or component or external device each time the computing device 106 is rebooted.

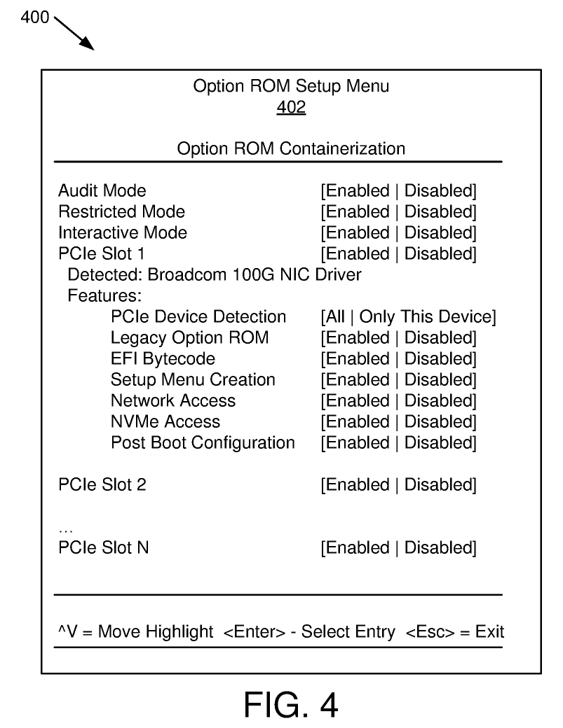

FIG. 4 is a schematic block diagram 400 illustrating an option ROM setup menu 402 for selecting options for option ROM containerization, according to various embodiments. The menu module 304 displays the option ROM setup menu 402 during the boot process. Note that the option ROM setup menu 402 includes basic text, which is often the case during the boot process. In other embodiments, the option ROM setup menu 402 is a more sophisticated menu that includes windows, colors, etc. typical of a menu displayed while the operating system is functioning. In some embodiments, the option ROM setup menu 402 includes an option ROM audit mode selection, which is the top line of the menu in FIG. 4 and offers “Enabled” and “Disabled” as selections.

In other embodiments, the option ROM setup menu 402 includes a selection of whether or not restricted mode is enabled or disabled. The option ROM setup menu 402 includes “Interactive Mode” with options of “Enabled” or “Disabled.” The next line of the option ROM setup menu 402 includes “PCIe Slot 1 with choices of “Enabled” or “Disabled.” The next line identifies that the PCIe card is detected as a Broadcom® 100 gigabyte NIC driver. Features for the PCIe card follow with a first option of “PCIe Device Detection” with a choice of “All” or “Only This Device.” The next line is “Legacy Option ROM” with choices of “Enabled” or “Disabled” and allows or disallows use a legacy option ROM. Allowing the legacy option ROM allows a BIOS boot process to be used with the option ROM apparatus 102.

The following lines include choices of “Enabled” or “Disabled” for Extensible Firmware Interface (“EFI”) byte code (or UEFI byte code), setup menu creation, network access, non-volatile memory express (“NVMe”) access, and post boot configuration. Following are options for other PCIe slots. At the bottom of the Option ROM Setup Menu are controls. Other option ROM processes may be added to other option ROM setup menus 402. The option ROM setup menus 402, in some embodiments, are customized for the component 114. In other embodiments, options on the option ROM setup menus 402 are comprehensive and include options for a multitude of components 114 with an option ROM 116.

The apparatus 300 includes, in some embodiments, an interactive mode module 306 configured to offer a user selection of an interactive mode. In response to the user selecting interactive mode and in response to the user selecting to disallow access for a process of the one or more option ROM processes and in response to the process requesting access during runtime, the interactive mode module 306 displays a prompt to the user to select disallowance of access for the process, to select a one-time allowance of access for the process, and to select a permanent allowance of access for the process. Thus, the interactive mode module 306 first allows a user to select or to disable the interactive mode. When the interactive mode is selected and a user has previously selected to disallow access by an option ROM process, when the disallowed option ROM process requests access, the interactive mode module 306 again presents the user with options for the option ROM process. The options are to disallow the option ROM process, to provide a one-time access to the option ROM process, and to allow permanent access to the option ROM process. Other embodiments, include other options to present during interactive mode.

In some embodiments, the apparatus 300 includes an audit option module 308 configured to allow a user to select or deselect an audit mode. The audit mode includes logging of access or denial of access for each of the one or more option ROM processes. In other embodiments, the audit option module 308 records information relevant to an option ROM process accessing or attempting to access a process, a component, etc. of the computing device 106 and accessing or attempting to access an external device. In some embodiments, the audit option module 308 turns on the logging of access or denial of access and other relevant information in response to a user selection of the audit option. In some embodiments, the audit option module 308 logs to a particular audit file when the user has selected the audit option. In some embodiments, the audit option module 308 logs access or denial of access using text.

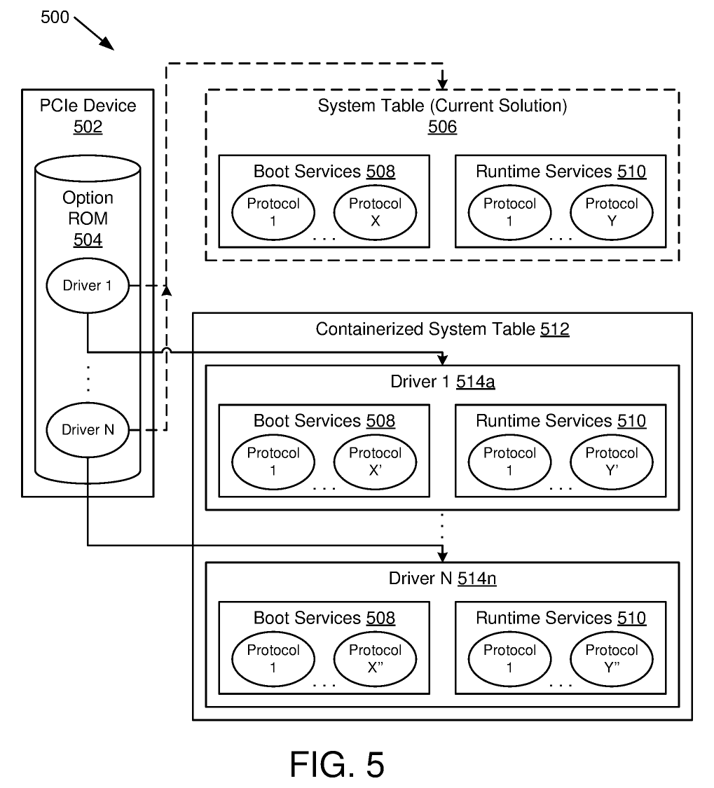

FIG. 5 is a schematic block diagram 500 illustrating a system table 506 currently in use for option ROM code 109 and a containerized system table 512, according to various embodiments. The diagram 500 includes a PCIe device 502, which is the component 114 of the computing device 106, that includes an option ROM 504 with multiple drivers. The option ROM 504 is the same as the option ROM 116 of FIG. 1. The dashed lines to the system table 506 is for current solutions where the system table 506 allows access to option ROM drivers for processes, components, and external devices without prohibiting any access. The system table 506 includes boot services 508 with various protocols and runtime services 510 with various protocols. The system table 506 is not in a container and thus allows access to option ROM processes.

The diagram 500 of FIG. 5 includes a containerized system table 512, which is inside the option ROM container 108. Driver 1 514a is for a first driver from the option ROM 504 is in the containerized system table 512 and includes various protocols for the boot services 508 and the runtime services 510. Each subsequent driver in the option ROM 504 includes a different driver up to driver N 514n in the containerized system table 512, where each includes protocols for boot services 508 and runtime services 510.

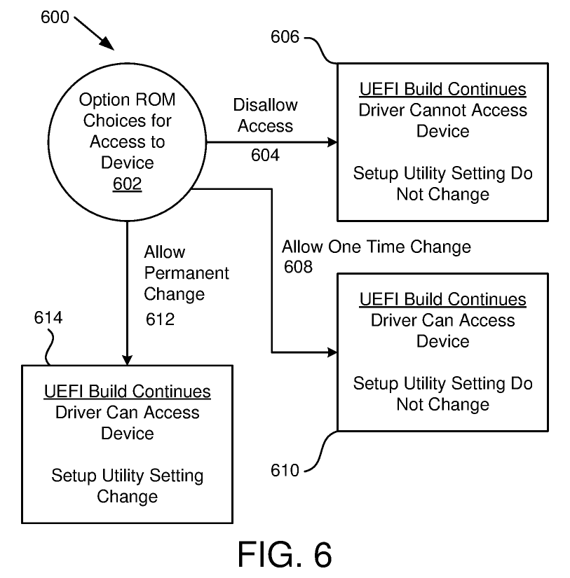

FIG. 6 is a schematic flow chart diagram 600 illustrating options for option ROM containerization, according to various embodiments. The option ROM choices for access to devices, processes, etc. 602 include disallow access 604, allow one time change 608, and allow permanent change 612. For the disallow access 604 selection includes that the driver cannot access the device 606. As part of the disallow access 604 choice, option ROM setup utility settings do not change. For the allow one time change 608, the driver can access the device 610 but the option ROM setup utility settings do not change. For the allow permanent change 612 choice, the driver can access the device 614 and the option ROM setup utility settings do change so that on the next boot process, the driver can still access the device 614.

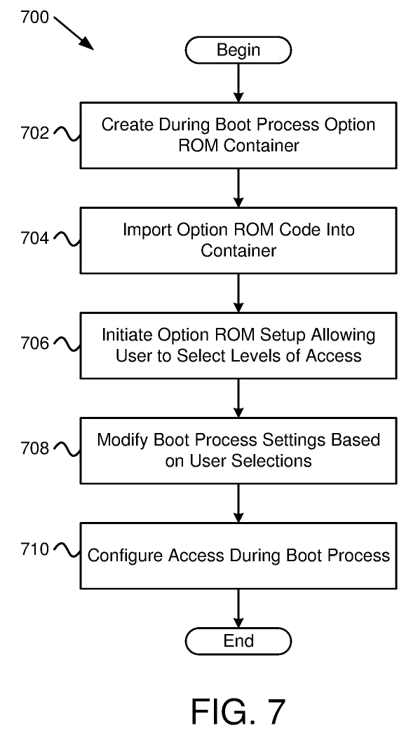

FIG. 7 is a schematic flow chart diagram illustrating a method 700 for option ROM containerization, according to various embodiments. The method 700 begins and creates 702, during a boot process of a computing device 106, an option ROM container 108 running on the computing device 106 and imports 704 option ROM code 109 from an option ROM 116 into the option ROM container 108. The option ROM 116 is located on a component 114 being installed on the computing device 106 and includes untrusted code. The method 700 initiates 706 an option ROM setup process during the boot process. The option ROM setup process includes allowing a user to select a level of access of one or more option ROM processes of the option ROM code 109.

The method 700 modifies 708 settings within boot process code of the boot process based on user selections of levels of access of the one or more option ROM processes to computer processes and components of the computing device 106 that are external to the option ROM container 108. In some examples, where the user selects permanent access, the method 700 changes settings within the boot process code so that during a next boot process, the option ROM processes selected for permanent access will continue to have access. Where a selection is to disallow access or one-time access, the method 700 does not modify the settings of the boot process code. The method 700 configures 710, during execution of the boot process code, access of the one or more option ROM processes based on the user selections, and the method 700 ends. For example, where the user selects one-time or permanent access for a option ROM process, the method 700 configures access for the option ROM process. In various embodiments, some or all of the method 700 is implemented using the container module 202, the import module 204, the level selection module 206, the code modification module 208, and/or the boot configuration module 210.

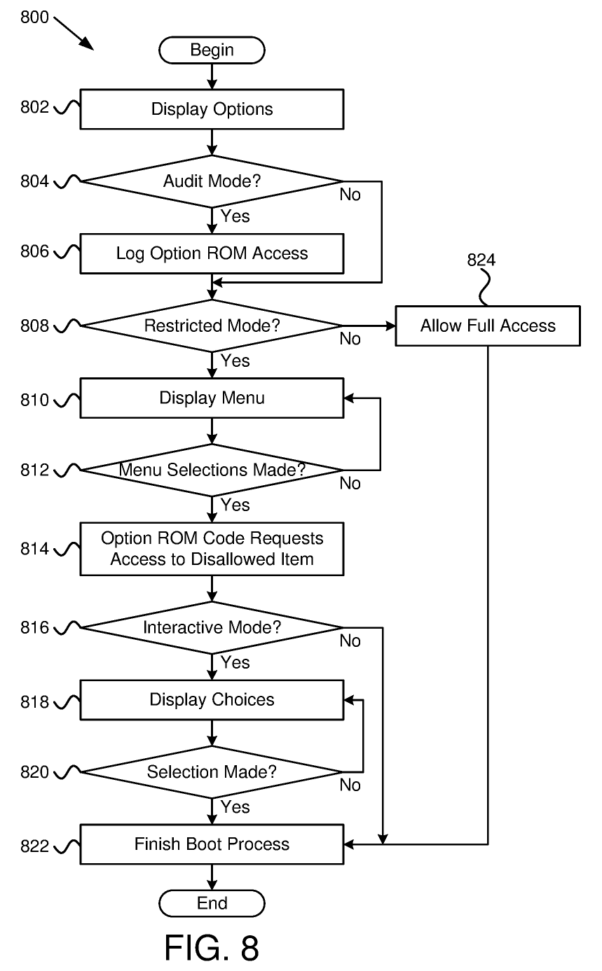

FIG. 8 is a schematic flow chart diagram illustrating another method 800 for user selection of options for option ROM containerization, according to various embodiments. The method 800 begins and displays 802 options associated with an option ROM 116 to a user. The options may include an audit mode selection, a restricted/unrestricted mode option, a menu of options, and an interactive mode option. The method 800 determines 804 if the user has selected audit mode. If the method 800 determines 804 that the user has selected audit mode, the method 800 logs 806 option ROM access or non-access to processes, components, and external devices in a log file and determines 808 if the user has selected restricted mode. If the method 800 determines 804 that the user has not selected audit mode, the method 800 determines 808 if the user has selected restricted mode.

If the method 800 determines 808 that the user has selected restricted mode, the method 800 displays 810 an option ROM setup menu 402 and determines 812 if menu selections have been made by the user. In various embodiments, the method 800 determines 812 if menu selections have been made in response to all options being selected, in response to a timeout, in response to the user selecting that the menu selections are complete, or the like. If the method 800 determines 812 that the menu selections have not been made by the user, the method 800 continues to determine 812 if the menu selections have been made by the user.

If the method 800 determines 812 that the menu selections have been made by the user, the method 800 determines 814 that the Option ROM Code 109 has requested access to a disallowed item from the Option ROM menu 402 and the method 800 determines 816 if the user has selected interactive mode. If the method 800 determines 816 that the user has selected interactive mode, the method 800 displays 818 choices to the user for the disallowed option ROM process. The choices, in some embodiments, include disallowing access for the option ROM process, a one-time access for the option ROM process, a permanent access for the option ROM process, and/or other options.

The method 800 determines 820 if a selection has been made for the disallowed option ROM process. If the method 800 determines 820 that a selection has not been made, the method 800 continues to display 818 choices for access to the disallowed option ROM process. If the method 800 determines 820 that a selection of a choice for access to the disallowed option ROM process has been made, the method 800 finishes 822 the boot process, and the method 800 ends. If the method 800 determines 808 that the user has selected the unrestricted mode, the method 800 allows 824 full access to the option ROM processes and finishes 822 the boot process, and the method 800 ends. If the method 800 determines 816 that the user has not selected interactive mode, the method 800 finishes 822 the boot process, and the method 800 ends. In various embodiments, all or a portion of the method 800 is implemented using the container module 202, the import module 204, the level selection module 206, the code modification module 208, the boot configuration module 210, the restricted mode module 302, the menu module 304, the interactive mode module 306, and/or the audit option module 308.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
creating, during a boot process of a computing device, an option read-only memory (“ROM”) container running on the computing device;
importing option ROM code from an option ROM into the option ROM container, the option ROM located on a component being installed on the computing device and comprising untrusted code;
initiating an option ROM setup process during the boot process, the option ROM setup process comprising allowing a user to select a level of access of one or more option ROM processes of the option ROM code;
modifying settings within boot process code of the boot process based on user selections of levels of access of the one or more option ROM processes to computer processes and components of the computing device external to the option ROM container; and
configuring, during execution of the boot process code, access of the one or more option ROM processes based on the user selections.

2. The method of claim 1, wherein modifying the settings within the boot process code comprises configuring the container with the option ROM code based on the user selections of the levels of access of the one or more option ROM processes.

3. The method of claim 1, wherein the levels of access comprise an unrestricted mode and a restricted mode, wherein user selection of the unrestricted mode comprises configuring the option ROM container to allow access by the one or more option ROM processes to the computer processes and components and wherein user selection of the restricted mode comprises configuring the option ROM container to restrict access for one or more of the one or more option ROM processes to the computer processes and the components.

4. The method of claim 3, wherein selection of the restricted mode further comprises displaying a menu comprising level of access options for the one or more option ROM processes.

5. The method of claim 4, wherein, for the one or more option ROM processes, the level of access options of the menu comprise disallowing access, a one-time allowance of access, and/or permanent allowance of access to the computer processes and the components, wherein:
the disallowing access comprises preventing access by the one or more option ROM processes to the computer processes and components;
the one-time allowance of access comprises a one-time allowance, until another boot process, of access by a process of the one or more option ROM processes to the computer processes and the components; and
the permanent allowance of access comprises a permanent allowance of access by a process of the one or more option ROM processes to the computer processes and components.

6. The method of claim 5, wherein in the restricted mode, further comprising offering a user selection of an interactive mode, wherein in response to the user selecting the interactive mode and in response to the user selecting to disallow access for a process of the one or more option ROM processes and in response to the process requesting access during runtime, further comprising displaying a prompt to the user to select disallowance of access for the process, to select a one-time allowance of access for the process, and to select a permanent allowance of access for the process.

7. The method of claim 5, wherein user selection of the disallowing of the access for the one or more option ROM processes comprises retaining settings of the boot process code for the one or more option ROM processes, wherein the one-time allowance of the access for the process of the one or more option ROM processes comprises retaining settings of the boot process code for the process of the one or more option ROM processes and a one-time allowance, until another boot process, of access by a process of the one or more option ROM processes to the computer processes and the components, and wherein user selection of the permanent allowance of access for the process of the one or more option ROM processes comprises modifying the boot process code to allow access to the process of the one or more option ROM processes.

8. The method of claim 1, further comprising offering the user an audit option, wherein a selection by the user of the audit option comprises logging of access or denial of access for each of the one or more option ROM processes.

9. The method of claim 1, wherein the boot process code comprises code for one of a Unified Extensible Firmware Interface (“UEFI”) process and a basic input/output system (“BIOS”) process.

10. The method of claim 1, further comprising isolating the option ROM code of the option ROM on the component being installed from execution and enabling execution of the option ROM code of the option ROM imported to the option ROM container.

11. An apparatus comprising:
a processor of a computing device; and
non-transitory computer readable storage media storing code, the code being executable by the processor to perform operations comprising during a boot process of the computing device:
creating an option read-only memory (“ROM”) container running on the computing device;
importing option ROM code from an option ROM into the option ROM container, the option ROM located on a component being installed on the computing device and comprising untrusted code;
initiating an option ROM setup process during the boot process, the option ROM setup process comprising allowing a user to select a level of access of one or more option ROM processes of the option ROM code;
modifying settings within boot process code of the boot process based on user selections of levels of access of the one or more option ROM processes to computer processes and components of the computing device external to the option ROM container; and
configuring, during execution of the boot process code, access of the one or more option ROM processes based on the user selections.

12. The apparatus of claim 11, wherein modifying the settings within the boot process code comprises configuring the container with the option ROM code based on the user selections of the levels of access of the one or more option ROM processes.

13. The apparatus of claim 11, wherein the levels of access comprise an unrestricted mode and a restricted mode, wherein user selection of the unrestricted mode comprises configuring the option ROM container to allow access by the one or more option ROM processes to the computer processes and components and wherein user selection of the restricted mode comprises configuring the option ROM container to restrict access for one or more of the one or more option ROM processes to the computer processes and the components.

14. The apparatus of claim 13, wherein the operations for selection of the restricted mode further comprise operations for displaying a menu comprising level of access options for the one or more option ROM processes.

15. The apparatus of claim 14, wherein, for the one or more option ROM processes, the level of access options of the menu comprise disallowing access, a one-time allowance of access, and/or permanent allowance of access to the computer processes and the components, wherein:
the disallowing access comprises preventing access by the one or more option ROM processes to the computer processes and components;
the one-time allowance of access comprises a one-time allowance, until another boot process, of access by a process of the one or more option ROM processes to the computer processes and the components; and
the permanent allowance of access comprises a permanent allowance of access by a process of the one or more option ROM processes to the computer processes and components.

16. The apparatus of claim 15, wherein in the restricted mode, the operations further comprise offering a user selection of an interactive mode, wherein in response to the user selecting the interactive mode and in response to the user selecting to disallow access for a process of the one or more option ROM processes and in response to the process requesting access during runtime, the operations further comprise displaying a prompt to the user to select disallowance of access for the process, to select a one-time allowance of access for the process, and to select a permanent allowance of access for the process.

17. The apparatus of claim 11, the operations further comprise offering the user an audit option, wherein a selection by the user of the audit option comprises logging of access or denial of access for each of the one or more option ROM processes.

18. A system comprising:
a computing device comprising a processor; and
a component being installed on the computing device, the component comprising an option read-only memory (“ROM”), the option ROM comprising untrusted code,
wherein the computing device comprises non-transitory computer readable storage media storing code, the code being executable by the processor to perform operations comprising during a boot process of the computing device:
creating an option read-only memory (“ROM”) container running on the computing device;
importing option ROM code from the option ROM into the option ROM container;
initiating an option ROM setup process during the boot process, the option ROM setup process comprising allowing a user to select a level of access of one or more option ROM processes of the option ROM code;
modifying settings within boot process code of the boot process based on user selections of levels of access of the one or more option ROM processes to computer processes and components of the computing device external to the option ROM container; and
configuring, during execution of the boot process code, access of the one or more option ROM processes based on the user selections.

19. The system of claim 18, wherein the levels of access comprise an unrestricted mode and a restricted mode, wherein the unrestricted mode configures the container to allow access by the one or more option ROM processes to the computer processes and components and wherein the restricted mode configures the container to restrict access for one or more of the one or more option ROM processes to the computer processes and the components.

20. The system of claim 19, wherein the operations for selection of the restricted mode further comprise operations for displaying a menu comprising level of access options for the one or more option ROM processes, and wherein, for the one or more option ROM processes, the level of access options of the menu comprise disallowing access, a one-time allowance of access, and/or permanent allowance of access to the computer processes and the components, wherein:
the disallowing access comprises preventing access by the one or more option ROM processes to the computer processes and components;
the one-time allowance of access comprises a one-time allowance, until another boot process, of access by a process of the one or more option ROM processes to the computer processes and the components; and
the permanent allowance of access comprises a permanent allowance of access by a process of the one or more option ROM processes to the computer processes and components,
wherein in the restricted mode, the operations further comprise offering a user selection of an interactive mode, wherein in response to the user selecting the interactive mode and in response to the user selecting to disallow access for a process of the one or more option ROM processes and in response to the process requesting access during runtime, the operations further comprise displaying a prompt to the user to select disallowance of access for the process, to select a one-time allowance of access for the process, and to select a permanent allowance of access for the process.
